(19) United States
(12) Patent Application Publication
(10) Pub. No.: US 2025/0355733 A1
(43) Pub. Date: Nov. 20, 2025

(54) MODIFYING SOFTWARE MODULES USING A DECLARATIVE APPLICATION PROGRAMMING INTERFACE

(71) Applicant: Twilio Inc, San Fancisco, CA (US)

(72) Inventors: Kentaro Kinebuchi, San Francisco, CA (US); Raffaele Abramini, London (GB); James Victor Smith Toohey, London (GB)

(21) Appl. No.: 18/667,651

(22) Filed: May 17, 2024

(51) Int. Cl. G06F 9/54; G06F 9/451

(52) U.S. Cl. CPC G06F 9/543; G06F 9/451; G06F 9/541

(57) ABSTRACT

A request to import a software module into an application having a graphical user interface (GUI) is received from a client device and by a software as a service (SaaS) platform. The software module is to modify the GUI of the application and written in a first format. A request to modify the software module is received via an application programming interface (API) call of a declarative API. The request identifies a software module modification written in a second format. The GUI of the application is provided for presentation based at least on the application and the software module modification in the second format.

### TECHNICAL FIELD

Aspects and embodiments of the disclosure relate to computer software, and more specifically, to systems and methods for modifying software modules using a declarative application program interface (API).

### BACKGROUND

Software applications can include code that enables functionality tailored to specific tasks. Modifying software applications can involve using tools like integrated development environments (EDI), version control systems, libraries, among other means, to alter, extend, or optimize the software application's behavior. Through meticulous application of these tools and methodologies, developers can ensure that software applications evolve to meet changing demands while maintaining optimal performance and functionality.

### BRIEF DESCRIPTION OF THE DRAWINGS

Aspects and embodiments of the disclosure will be understood more fully from the detailed description given below and from the accompanying drawings of various aspects and embodiments of the disclosure, which, however, should not be taken to limit the disclosure to the specific aspects or embodiments, but are for explanation and understanding.

FIG. 1 illustrates an example system architecture, in accordance with some embodiments of the disclosure.

FIG. 2 illustrates an example system architecture used for modifying one or more software modules corresponding to an application, in accordance with some embodiments of the disclosure.

FIG. 3 illustrates a sequence diagram of modifying software modules in a declarative manner, in accordance with embodiments of the disclosure.

FIG. 4 depicts a flow diagram of an example method for modifying a software module using a declarative API, in accordance with some embodiments of the disclosure.

FIG. 5 is a block diagram illustrating an exemplary computer system, in accordance with some embodiments of the disclosure.

### DETAILED DESCRIPTION

A communication services platform, such as a Software as a Service (SaaS) platform, can offer various communication services to users. For example, a SaaS platform can offer messaging service tools that facilitate messaging conversations, e.g., the sending and/or receiving of messages, such as SMS messages, MMS messages, and/or IM messages, to and from devices via various communication channels. A communication channel can refer to a form of communication that uses one or more of a particular protocol, a particular underlying technology or is provided by a particular entity (e.g., third-party entity). Different communication channels can refer to different forms of communication that can use one or more of different communication protocols, different underlying technologies (e.g., SMS vs IP), or are provided by different entities, such as a third-party entity, that offer services, software or hardware (or a combination thereof) through which messages can be exchanged between recipient devices. For instance, the SaaS platform may send a text message (e.g., SMS message) to a recipient device using a communication channel, such as a telecommunications carrier network or send an instant message to a recipient device using an IM communication channel (e.g., using an application programming interface (API) to communicate with the IM communication channel). Examples of channels can include Public Switched Telephone Network (PSTN) based channels such as SMS or MMS, Internet Protocol (IP) based channels, and proprietary channels (e.g., proprietary social media messaging applications).

To allow users to interact with the aforementioned services, as well as others, a platform can develop and deploy applications that allow client devices associated with the users to interact with the platform. The users can be part of a client organization, and the client organization may want to customize the application, and in particular the graphical user interface (GUI) of the application to suite the needs and preferences of the client organization. In some instances, the client organization can select or design and develop one or more modules, such as plugins or extensions that customize the existing application by modifying (e.g., adding, moving, changing, or removing) features and objects. For example, the client organization may desire to customize a GUI of an application such that the customized GUI rendered in corporate themes (e.g., colors, design, etc.) and/or to include GUI elements that are specific to the organization. The existing application along with the modules can be deployed by the platform for the client organization such that the users of the client organization can experience the customized application via the execution of the client-defined modules.

Implementing a module-based customization solution can present several challenges. Modules can be “hardcoded” such that to modify modules the source code is modified to change specific values and configurations. Such module modification may demand a rewrite of the source code of the module, which is antithesis of productivity in a low code or no code software environment. Also, modules and module modifications can conflict with other modules which is difficult to detect and/or correct. Further, platforms may not desire to allow full customization of an application but rather prefer to implement “guard rails” or constraints and/or boundaries to guide or restrict certain changes of an application via modules or module modifications.

Aspects of the disclosure address the above-mentioned and other challenges by implementing declarative tools, such as application programming interface (API) calls of a declarative API, that allow the modification of software modules in a declarative manner. In some embodiments, a “hardcoded” software module in a first format (e.g., source code in a first programming language) can developed by, for example, the client organization and deployed by a SaaS platform to customize an existing application associated with the SaaS platform. At some point, the client organization may desire to modify the software module. Rather than re-write the source code of the software module, the client organization can send a request, via an API call of a declarative API, requesting a software module modification to the software module. For example, the API call identify that a particular GUI element (e.g., in a declarative manner such ADD GUI element A) is to be added to the software module. The software module modification can be written in a second format that is different than the first format of the software module. The SaaS platform can provide for presentation at one or more client devices the modified GUI of the application using at least the application and the software module modification written in the second format.

In some embodiments, the software module (or at least part of the software module) and/or application can be converted from the first format to a second format. For example, the software module written in a first programming language can be converted to another format, such as a data interchange format (e.g., JavaScript Object Notation (JSON)). The software module modification can also be written in the second format, which in some embodiments, can allow the modification to be requested in declarative manner (e.g., the second format allows for declarative statements, such as statements pertaining to modifications to the software module).

In some embodiments, a schema can be implemented that corresponds to the second format. The schema (e.g., JSON schema) can define one or more of properties, behaviors and/or data types (e.g., set of rules) are acceptable for data in the second format. In some embodiments, the schema is configurable (e.g. configurable by the SaaS platform). The schema can allow the SaaS platform to apply constraints or rules to software modules and/or software module modifications.

In some embodiments, the software module modification can be validated. At validation, the software module modification in the second format can be checked against the schema to verify whether the software module modification conforms to the schema. In some embodiments, at validation the SaaS platform can also determine whether the software module modification in the second format conflicts with one or more of the software module (in the second format) being modified, other software module(s) in a second format, or the application (in the second format). If a conflict is determined, the software module modification (and/or software module(s) or application) can be further modified in a declarative matter to resolve the conflict.

As noted, a technical problem addressed by some embodiments of the disclosure is providing tools that allow the modification of “hard coded” software modules in a low code or no code environment. Another technical problem addressed by some embodiments of the disclosure is implementing constrains on customizations of an application. Another technical problem addressed by some embodiments of the disclosure is identifying and/or correcting conflicts for and between software modules and/or software module modifications and/or the application.

A technical solution to the above-identified technical problem(s) may include providing API calls of a declarative API that facilitate modifications to software modules in a declarative manner. Another technical solution to the above-identified technical problem(s) may include receiving the software module modification written in a second format that corresponds to a schema that can define the rules for modifications. A technical solution to the above-identified technical problem(s) may include validating the software module modification written in the second format against the schema and/or validating the software module modification to determine whether one or more conflicts exist.

Thus, the technical effect may include providing the technical infrastructure to modify “hard coded” software module in a declarative manner.

A software module (also referred to as “module” herein) can refer to software having a unit of functionality within a larger software system or software application. In some embodiments, the features and/or behavior can be used across parts of the software system and/or software application. In some embodiments, a software module can be developed after the existing software application is developed (and/or deployed) to add additional functionality to the existing software application. For example and in some embodiments, the SaaS platform can develop a software application for use by one or more clients. The client can develop and/or implement one or more software modules for the existing software application to, for example, customize the software application for the client. Examples of a software module can include but are not limited to plugins and extensions. A plugin can refer to a software component that adds specific features and functionalities to an existing software application without, in some cases, modifying the source code (e.g., codebase) of the existing software application. Extensions can provide additional capabilities to a software application.

Format can refer to one or more of the structure or arrangement of data, code, or text in accordance with a syntax or set of rules. In some embodiments, the format can define how information is represented, organized and/or processed within a programming environment. Format can include one or more of data format, file format, code format, or protocol format.

Declarative (e.g., declarative manner) as used herein, unless otherwise indicated can refer to a programming or computational approach where the system is provided a description of a desired outcome or goal. Rather than providing specific instructions on how to achieve the outcome or goal, the system can determine operations for execution to achieve the outcome or goal. Declarative approaches can contrast with imperative approaches where instructions are given to a system is a step-by-step manner to achieve a desired outcome or goal.

A declarative API can refer to an interface and/or set of functions (e.g., API calls) that allow interaction with a system or platform by declaring an outcome or an intent (e.g., rather than specifying steps to achieve the outcome or the intent). For example, a declarative API can include an API call that allows a client device to add a GUI element to an application having a GUI or module using a declaration of the outcome (e.g., ADD GUI element A to area A).

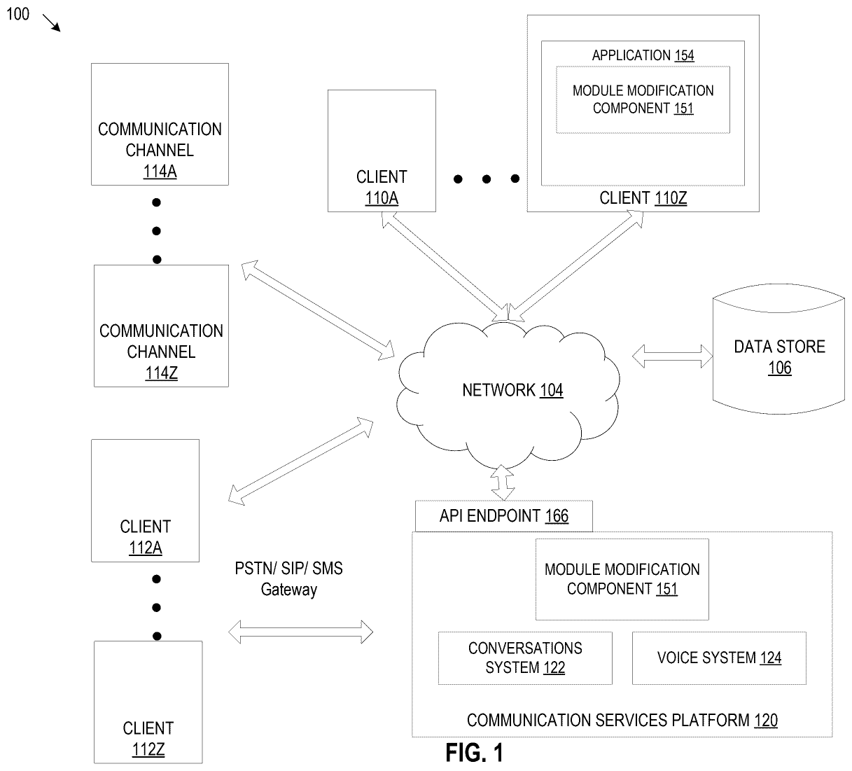

FIG. 1 illustrates an example system architecture 100, in accordance with some embodiments of the disclosure. The system architecture 100 (also referred to as “system” herein) includes a communication services platform 120, a data store 106, client devices 110A-110Z connected to a network 104, client devices 112A-112Z communicatively coupled to communication services platform 120, and communication channels 114A-114Z coupled to the network 104 (or otherwise communicatively coupled to other elements of the system 100).

In embodiments, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some embodiments, data store 106 is a persistent storage that is capable of storing data as well as data structures to tag, organize, and index the data. Data store 106 may be hosted by one or more storage devices, such as main memory, magnetic or optical storage-based disks, tapes or hard drives, NAS, SAN, and so forth. In some embodiments, data store 106 may be a network-attached file server, while in other embodiments data store 106 may be some other type of persistent storage such as an object-oriented database, a relational database, and so forth, that may be hosted by communication services platform 120 or one or more different machines coupled to the communication services platform 120 via the network 104.

The client devices 110A-110Z (generally referred to as “client device(s) 110” herein) may each include a type of computing device such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some embodiments, client devices 110 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some embodiments, client devices 110A through 110Z may also be referred to as “user devices.”

In some embodiments, a client device, such as client device 110Z, can implement or include one or more applications, such as application 154 (also referred to as “client application 154” herein) executed at client device 110Z. In some embodiments, application 154 can be used to communicate (e.g., send and receive information) with communication services platform 120. In some embodiments, application 154 can implement user interfaces (e.g., graphical user interfaces (GUIs)) that may be webpages rendered by a web browser and displayed on the client device 110Z in a web browser window. In another embodiment, the user interfaces of client application 154 may be included in a stand-alone application downloaded to the client device 110Z and natively running on the client device 110Z (also referred to as a “native application” or “native client application” herein).

In some embodiments, client devices 110 can communicate with communication services platform 120 using one or more function calls, such as application programming interface (API) function calls (also referred to as “API calls” herein). For example, the one or more function calls can be identified in a request using one or more application layer protocols, such a HyperText Transfer Protocol (HTTP) (or HTTP secure (HTTPS)), and that are sent to the communication services platform 120 from the client device 110Z implementing application 154. In some embodiments, the communication services platform 120 can respond to the requests from the client device 110Z by using one or more API responses using an application layer protocol. Similarly, communication services platform 120 can communicate with one or more communication channels 114A-114Z using API function calls.

In some embodiments, one or more of client devices 110 can be identified by a uniform resource identifier (URI), such as a uniform resource locator (URL). For example, communication services platform 120 can send an API call to client device 110Z addressed to a URL specific to the client device 110Z. In some embodiments, the communication services platform 120 can be identified by a URI. For instance, the API call sent by a client device 110 to communication services platform 120 can be directed to the URL of communication services platform 120.

In some embodiments, the APIs used to access the conversations system 122 of the communication services platform 120 can be different from the APIs used to access the voice system 124 of communication services platform 120. In some embodiments, the APIs used by application 154 executed on a desktop client device (e.g., desktop application) to access the voice system 124 can be different APIs than the APIs used by application 154 executed on a mobile client device (e.g., mobile application) to access the voice system 124. In some embodiments, conversations system 122 and voice system 124 can communicate between one another using APIs. In some embodiments, the APIs used to communicate between conversations system 122 and voice system 124 may be private APIs that are not accessible by client devices 110 (or client devices 112).

In some embodiments, client devices 112A-112Z (generally referred to as “client device(s) 112” herein) may be similar to client devices 110. In some embodiments, client devices 112 can include one or more telephony devices. A telephony device can include a Public Switched Telephone Network (PSTN)-connected device, such as a landline phone, cellular phone, or satellite phone, for example. In some embodiments, a telephony device can also include an internet addressable voice device (e.g., non-PSTN telephony device), such as Voice-Over-Internet-Protocol (VOIP) phones, or Session Initiation Protocol (SIP) devices, for example. In some embodiments, a telephony device can include one or more messaging devices, such as a Short Message Service (SMS) network device that, for example, uses a cellular service to exchange SMS messages or Multimedia Messaging Service (MMS) messages.

In some embodiments, the communication services platform 120 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components that may be used to provide a user with access to data or services. Such computing devices may be positioned in a single location or may be distributed among many different geographical locations. For example, communication services platform 120 may include a plurality of computing devices that together may comprise a hosted computing resource, a grid computing resource or any other distributed computing arrangement. In some embodiments, communication services platform 120 may correspond to an elastic computing resource where the allotted capacity of processing, network, storage, or other computing-related resources may vary over time.

In some embodiments, communication services platform 120 provides one or more API endpoints 166 that can expose services, functionality or content of the communication services platform 120 to one or more of client devices 110 or communication channels 114A-114Z. In some embodiments, an API endpoint 166 can be one end of a communication channel, where the other end can be another system, such as a client device 110Z or communication channel 114Z. In some embodiments, the API endpoint 166 can include or be accessed using a resource locator, such a universal resource locator (URL), of a server or service. The API endpoint 166 can receive requests from other systems, and in some cases, return a response with information responsive to the request. In some embodiments, HTTP or HTTPS methods can be used to communicate to and from API endpoint 166.

In some embodiments, the API endpoint 166 (also referred to as a “request interface” herein) can function as a computer interface through which communication requests, such as message and/or voice requests, are received and/or created. The communication services platform 120 may include one or more types of API endpoints.

In some embodiments, the API endpoint 166 can include a messaging API and/or voice API whereby external entities or systems can send a communication to create message content and/or request sending of a message and/or request voice services that are provided via voice system 124. The API (e.g., message API and/or voice API) may be used in programmatically creating message content and/or requesting sending of one or more messages and/or requesting the transfer or joining client device(s) to a voice call. In some embodiments, the API is implemented in connection with a multitenant communication service wherein different accounts (e.g., authenticated entities) can submit independent requests. These requests made through the API can be managed with consideration of other requests made within an account and/or across multiple accounts on the communication service.

In some embodiments, the API of the API endpoint 166 may be used in initiating general messaging or communication requests. For example, a messaging request may indicate one or more destination endpoints (e.g., recipient phone numbers), message content (e.g., text and/or media content), and possibly an origin endpoint (e.g., a phone number to use as the “sending” phone number).

In some embodiments, the API of the API endpoint 166 may be any suitable type of API such as a REST (Representational State Transfer) API, a GraphQL API, a SOAP (Simple Object Access Protocol) API, and/or any suitable type of API. In some embodiments, the communication services platform 120 can expose through the API, a set of API resources which when addressed may be used for requesting different actions, inspecting state or data, and/or otherwise interacting with the communication platform.

In some embodiments, a REST API and/or another type of API may work according to an application layer request and response model. An application layer request and response model may use HTTP (Hypertext Transfer Protocol), HTTPS (Hypertext Transfer Protocol Secure), SPDY, or any suitable application layer protocol. Herein HTTP-based protocol is described for purposes of illustration rather than limitation. The disclosure should not be interpreted as being limited to the HTTP protocol. HTTP requests (or any suitable request communication) to the communication services platform 120 may observe the principles of a RESTful design or the protocol of the type of API. RESTful is understood in this document to describe a Representational State Transfer architecture. The RESTful HTTP requests may be stateless, thus each message communicated contains all necessary information for processing the request and generating a response. The API service can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

In some embodiments, the API endpoint 166 can include a request instruction module that can be called within an application, script, or other computer instruction execution. For example, a computing platform may support the execution of a set of program instructions where at least one instruction within a script or other application logic is used in specifying a message request and communicating that request.

In some embodiments, the API endpoint 166 can include a console, administrator interface, or other suitable type of user interface. Such a user-facing interface can be a graphical user interface. Such a user interface may additionally work in connection with a programmatic interface.

In some embodiments, a request, such as a message request, can include a data object characterizing the properties of a message. In some embodiments, the communication services platform 120 is associated with message requests that are programmatically initiated (e.g., an application-to-person (A2P) message). In some embodiments, the message request could be one initiated from an inbound received message.

In some embodiments, a request (e.g., message request and/or voice request) can include one or more of one or more destination endpoints, one or more origin endpoints, and message content and/or audio content. In some embodiments, one or more of these properties may be specified indirectly such as through system or account configuration or identifier (e.g., messaging conversation identifier). For example, all messages may be automatically assigned an origin endpoint that is associated with an account. In some embodiments, the message content can include any suitable type of media content including, text, audio, image data, video data, multimedia, interactive media, data, and/or any suitable type of message content.

In an illustrative example, used for illustration rather than limitation, communication services platform 120 can include a Software as a Service (SaaS) platform that can at least in part provide one or more services, such as communication services, to one or more clients. The SaaS platform may deploy services, such as software applications, to one or more clients for use as an on-demand service. For example, the SaaS platform may deliver and/or license software applications on a subscription basis while also hosting, at least in part, the software application. The licensed software applications can, at least in part, be hosted on the infrastructure, such as the cloud computing resources of the SaaS platform.

In some embodiments, communication services platform 120, as noted above, can provide communication services that include, but are not limited to, voice services, messaging services (e.g., SMS services or MMS services), email services, video services, chat messaging services (e.g., internet-based chat messaging services), or a combination thereof. Communication operations using the communication services can use one or more of a communication network (e.g., Internet), telecommunications network (e.g., such as a cellular network, satellite communication network, or landline communication network), or a combination thereof, to transfer communication data between parties.

In some embodiments, the conversations system 122 can function to interface with one or more communication network(s) and/or service(s) for communication of a conversation (e.g., a messaging conversation, such as SMS, MMS, and/or chat messaging). In some embodiments, the conversations system 122 can include an interface to one or more carrier-based communication routes used in sending SMS, MMS, and/or other carrier-based messages. There may be multiple carrier-based communication routes that serve as different optional “routes” when sending communications over a carrier-based network (e.g., a mobile network). The conversations system 122 may additionally or alternatively include an interface to one or more over-the-top (OTT) communication channels which may be offered by a third-party messaging platform (e.g., proprietary social media messaging, messaging applications, etc.).

A route can refer to a communication delivery path, defined by a series of one or more of computers, routers, gateways and/or carrier networks through which the communication is transferred from a source computer to a destination computer (e.g., through which the transmission of a message occurs). For example, the same route may be used to transfer messages using different communication channels, and the same communication channel may be used to transfer messages using different routes. In some example embodiments, different channels correspond to different applications on a receiving device. For example, a smart phone may have one application to handle SMS messages, another application to handle email, and a third application to handle voicemail. Alternatively, some applications may handle multiple communication channels. For example, one application may handle both SMS and MMS messages.

In some embodiments, when the conversations system 122 elects to send a message using a carrier-based channel, the message is communicated to an appropriate carrier connection for routing to the destination endpoint. Carrier-based channels can use SMPP (Short Message Peer-to-Peer protocol) for communicating to an aggregator or another suitable gateway such that the SMS/MMS message is transferred over a carrier network. Once transmitted to the carrier network, the message can be relayed appropriately to arrive at the intended destination. A message in transit may have multiple routing segments that are used in the delivery to an end destination device.

For example, the conversations system 122 can include an interface to one or more SMS Gateways that enable a computer to send and receive SMS text messages to and from a SMS capable device over the global telecommunications network (normally to a mobile phone). The SMS Gateway translates the message sent and makes it compatible for delivery over the network to be able to reach the recipient. The different SMS gateways (or more generally message gateways) can serve as different route options when the conversations system 122 is determining a channel and/or route to be used for one or more message transmissions.

In some embodiments, SMS Gateways can route SMS text messages to the telco networks via an SMPP interface that networks expose, either directly or via an aggregator that sells messages to multiple networks. SMPP, or Short Message Peer-to-Peer, is a protocol for exchanging SMS messages between Short Message Service Centers (SMSCs) and/or External Short Messaging Entities (ESMEs).

In some embodiments, the destination of a message may be used in determining the candidate message routes (and/or channels). For example, a phone number of a destination endpoint or another identifier associated with the intended recipient of the message may be used to identify the destination network of the intended recipient. Each destination network may be assigned a Mobile Country Code (MCC)/Mobile Network Code (MNC) pair that identifies the specific destination network.

In some embodiments, communication services platform 120 includes a conversations system 122 that can use the phone number associated with the intended recipient of the message to lookup the MCC/MCN pair identifying the destination network. For example, the conversations system 122 can determine the MCC/MNC pair using an MCC/MNC directory that lists the MCC/MNC pair corresponding to each phone number. In some embodiments, the MCC/MNC directory may be stored in a routing provider storage. Alternatively, the MCC/MNC directory may be stored at some other network accessible location. In either case, the conversations system 122 can use the phone number associated with the intended recipient of the message to query the MCC/MNC directory and identify the MCC/MNC pair that identify the corresponding destination network.

In some embodiments, the conversations system 122 can use the MCC/MNC pair retrieved from the MCC/MNC directory to identify candidate routing providers and routes that are available to deliver a message to the destination network identified by MCC/MNC pair. For example, the routing provider storage may include a routing provider directory that lists each MCC/MNC pair serviced by the conversations system 122 and the corresponding routing providers and routes available for use with each MCC/MNC pair. That is, the routing provider directory can list the routing providers and routes that are available to the conversations system 122 to deliver messages to the destination network identified by each MCC/MNC pair listed in the routing provider directory.

In some embodiments, voice system 124 of communication services platform 120 can enable the placement of an outbound voice call and/or routing of an inbound voice call. A voice call (also referred to as a “call” herein) can refer to a telephone call between at least two user devices to communicate two-way voice data (e.g., voice sound) in real-time. An outbound voice call can refer to a voice call from a client device 110 associated with an account (e.g., one or more of an organization's account or user account) of the communication services platform 120, and to another device that may not be associated with an account. An inbound voice call can refer to a voice call from a device that may not be associated with an account, and to a client device 110 associated with an account. It can be appreciated that a voice call between two client devices 110 that are associated with an account can be performed using communication services platform 120. Such voice calls can be considered inbound or outbound voice calls relative to the particular client device 110.

In some embodiments, voice system 124 can include one or more voice services used in conjunction with a voice call. In some embodiments, the one or more voice services can include a transcription service that transcribes speech to text. In some embodiments, the one or more voice services can include a recording service that can record the audio data of the voice call. In some embodiments, the one or more voice services can include a voice call queue service that can queue inbound voice calls and release the queued voice call pursuant to user-defined logic. In some embodiments, the one or more voice services can include voice mailbox services that store voice messages of at least inbound calls. In some embodiments, the one or more voice services can include an interactive voice response (IVR) service that interacts with callers and gathers information for them by giving the callers choices via a menu, and then performs the actions based on the answers of the caller through the telephone keypad or through voice response. For example, the IVR service can allow a caller to interact with the back-end telephony system, such as voice system 124, by pressing keys that emit dual-tone multi-frequency (DTMF) signals or saying words that are processed by a speech recognition system. In some embodiments, the one or more voice services can include conference call service that can connect three or more devices in a single call.

In some embodiments, communication services platform 120 can include a multitenant system. Multitenancy can refer to a mode of operation of software applications where multiple independent instances of one or multiple applications operate in a shared computer environment. In some embodiments, the instances (tenants) can be logically isolated, but physically integrated. The degree of logical isolation can be complete, but the degree of physical integration can vary. The tenants (application instances) can be representations of organizations that obtain access to the multitenant system. The tenants may also be multiple applications competing for shared underlying resources. Multiple organizations can access the resources of communication services platform 120 without any indication that the resources are shared between the multiple organizations. The data of each of the organizations can be logically isolated from one another such that each organization has access to their own data but not the data of other organizations in the multitenant system. In some embodiments, communication services platform 120 can include a single tenant system.

An organization can be an example of an entity, such as a legal entity, that includes multiple people and that has a particular purpose. A non-limiting example of an organization includes a corporation (e.g., authorized by law to act as a single entity or legal entity). In some embodiments, multiple organizations can include one or more organizations that are independent or distinct from the other organizations. For example, a first organization can be corporation A and a second organization can be corporation B. Corporation A can be considered an independent legal entity from corporation B. Each of corporation A and corporation B can make independent decisions and have a different legal or corporate structure.

In some embodiments, a “user” may be represented as a single individual. However, other embodiments of the disclosure encompass a “user” being an entity controlled by a set of users and/or an automated source. For example, a set of individual users federated as one or more departments in an organization may be considered a “user.” In general, functions described in one embodiment as being performed by the communication services platform 120 can also be performed on the client devices 110A through 110Z in other embodiments (and vice versa), if appropriate. In addition, the functionality attributed to a particular component can be performed by different or multiple components operating together. The communication services platform 120 can also be accessed as a service provided to other systems or devices through appropriate APIs.

As noted above and in some embodiments, a communication channel can refer to an entity, such as a third-party entity (e.g., organizations different from communication services platform 120), that offers services, software or hardware (or a combination thereof) through which messages can be sent to recipient devices. (e.g., organizations different from communication services platform 120). A third party can refer to an entity, such as organization or business (e.g., a different legal entity than communication services platform 120) that is distinct from another entity, such as the entity controlling or owning the communication services platform 120. In some embodiments, the communication services offered by communication channels 114A-114Z can be integrated into communication services platform 120. In some embodiments, the communication services offered by communication channels 114A-114Z can include messaging services. In some embodiments, messaging services can include one or more of a short messaging service (SMS) offered by an SMS channel, a multimedia messaging service (MMS) offered by an MMS channel, or an instant messaging service (e.g., chat messaging) offered by an instant messaging service channel. In some embodiments, communication channels 114A-114Z can also include a voice channel. For example, the voice channel may implement an application to send or receive calls. In another example, the voice channel may include a telecommunication service provider and/or PSTN voice services.

In some embodiments, an instant messaging service is different from an electronic mail (email) service. In some embodiments, the communication channels 114A-114Z can include an email channel. In some embodiments, the communication channels 114A-114Z exclude an email channel. In some embodiments, email messages can use a standard protocol for sending and receiving email messages. The standard protocol can be used across different platforms. In some embodiments, instant messages can use protocols specific to a platform that may or may not be compatible with other platforms. In some embodiments, instant messaging can differ from email in that conversations over instant messaging can happen in real-time, while conversations over email are not in real-time.

In some embodiments, client device 110Z may want to modify a software module that corresponds to an application (e.g., application implementing a GUI) using module modification component 151 of client device 110Z and/or module modification component 151 of communication services platform 120. In some embodiments, communication services platform 120 and/or client devices 110 include an instance of module modification component 151. In some embodiments, module modification component 151 of client device 110Z, of communication services platform 120, or a combination thereof can perform one or more aspects or embodiments of the disclosure.

In some embodiments, an entity (e.g., organization) can be associated with an account (e.g., organizational account) of communication services platform 120. Within the particular account (e.g., organizational account) of the organization, one or more user accounts of the communication services platform 120 may be associated with different users of the organization. In some embodiments, the accounts are organized in a hierarchical structure where the organizational account is the root at the top of the hierarchy and the user accounts are nested under the organizational account.

In some embodiments, communication services platform 120 can provision telephone numbers (e.g., 10-digit long code or short code) to an organization's account and assign the telephone numbers to various user accounts associated with the organization. The assignment of telephone numbers can be flexible such that the assignment of a telephone number can be one to one (e.g., one telephone number to one user account) or one to many (e.g., one telephone number to many user accounts).

In some embodiments, communication services platform 120 can dynamically assign or transfer the telephone numbers. For example, user account A may be assigned telephone number A. Telephone number A can be transferred and assigned to another user account Z and unassigned from user account A, or can be assigned to user account Z and user account A, for instance.

In some embodiments, voice calls and messages can be dynamically routed or sent to and from different telephone numbers. For instance, a user account A may be assigned telephone number A. Telephone number A may have an area code corresponding to Texas. User account A, via application 154 of client device 110A, sends, via communication services platform 120, a message A to an end user device. The end user device can be associated with a telephone number with an area code associated with the state of California. Communication services platform 120 can associate a telephone number with a California area code to the message conversation and send message A to end user device from the associated telephone number with a California area code. From the perspective of the end user device, the message A can appear to be sent from the telephone number with a California area code, rather than from the telephone number A with a Texas area code.

In some embodiments, the telephone number of the client device 110 (e.g., telephone number assigned to the client device 110 by the telecommunications carrier) can be different than the telephone number that is assigned to the user account associated with the client device 110. In some embodiments, the client device 110 may not have a telephone number assigned by a telecommunications carrier. For instance, the client device 110A may be a desktop computer. In some embodiments, the client device 110A can be identified by an internet protocol (IP) address and can send messages of the message conversation using a protocol such as HTTP over TCP/IP (transmission control protocol) or can place a voice call using a Voice over IP (VOIP) protocol (e.g. SIP) via application 154, for example.

Although embodiments of the disclosure are discussed in terms of communication service platforms, embodiments may also be generally applied to any type of platform, system or service.

In situations in which the systems discussed here collect personal information about users, or may make use of personal information, the users may be provided with an opportunity to control whether the communication services platform 120 collects user information, or to control whether and/or how to receive content from the communication services platform 120 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the communication services platform 120.

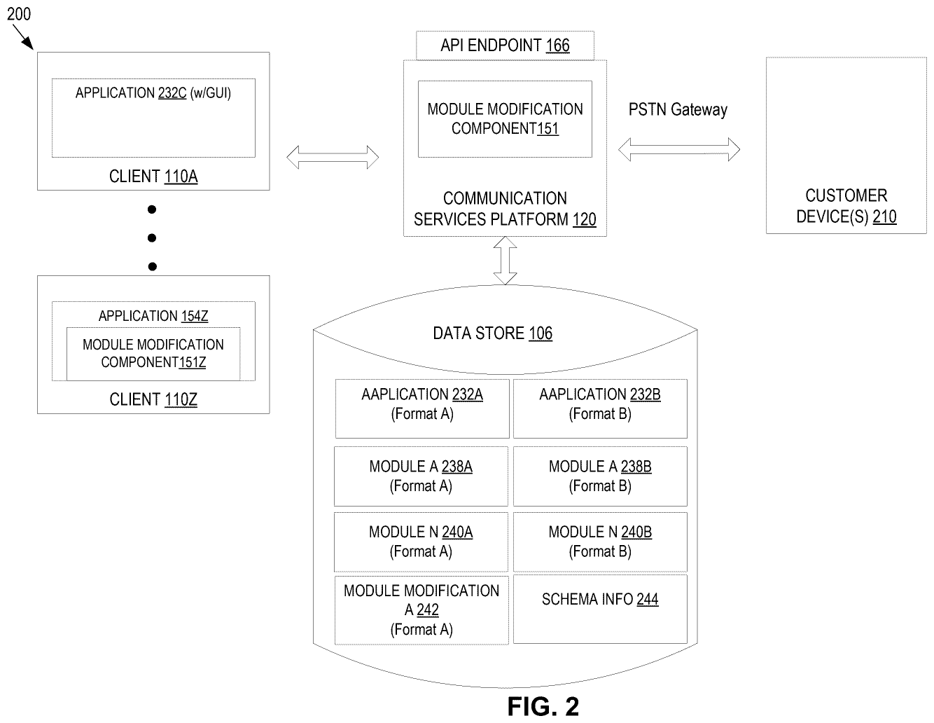

FIG. 2 illustrates an example system architecture 200 used for modifying one or more software modules corresponding to an application, in accordance with some embodiments of the disclosure. Components of FIG. 1 are used to help describe aspects of FIG. 2. The system architecture 200 (also referred to as “system” herein) includes a communication services platform 120, a data store 106, one or more client devices 110A through 110Z and customer device(s) 210. In some embodiments, module modification component 151 can perform one or more of the operations described with respect to communication services platform 120. In some embodiments, module modification component 151Z can perform one or more of the operations described with respect to client device 110Z.

As illustrated, client device(s) 110Z can communicate with communication services platform 120 using application 154Z. In some embodiments, instances of application 154 are provided by communication services platform 120 to client device 110A through 110Z to facilitate module management between one or more of client devices 110 and communication services platform 120.

In an illustrative example and in some embodiments, users of client devices 110 can be part of an organization that uses one or more communication services provided by communication services platform 120. The users of the client devices 110 can each be assigned a user account (e.g., unique user account) that is associated with the organization and that allows access to the communication services provided by communication services platform 120. The organization may use the communication services platform 120 to facilitate messaging conversations and/or voice calls with customers (e.g., customers of the organization, rather than the communication services platform 120 and represented by customer device 210). For instance, client device 110A, via application 232C, can conduct a text messaging conversation and/or a voice call with a customer (e.g., customer device 210). Customer can also be referred to as “end user” herein.

In some embodiments, client device 110Z can correspond with user account of an administrator of the organization. In some embodiments, the user account of the administrator can have permissions to manage (e.g., identify, create, and/or deploy) software module(s) on behalf of the organization and for an application, such as application 232C, and/or have permissions to manage modifications to software modules. The administrator can use an application 154Z to manage software module(s). In some embodiments, application 154Z may be different than application 232C. In some embodiments, the organization may have other employees that are associated with other user accounts that do not have the permissions of the administrator. The user accounts of the employees can be used to access the services of the communication services platform 120 using application 232C. Application 232C can implement a GUI or be a GUI application in some embodiments. In some embodiments, the application 232C can be deployed by communication services platform 120 and be modified by the organization (e.g., via application 154Z). In some embodiments, application 154Z and application 232C may be instance of the same application.

In some embodiments, an application that implements a GUI, such as application 232C, can refer to a type of application that implements a GUI that allows users to interact with a program through components, such as GUI elements, such as one or more of windows, buttons, menus, and/or icons rather than solely through text-based input (e.g., text-based interfaces). A GUI element can refer to a visual component or element that allows a user to interact with a GUI and/or underlying application. GUI elements can be used to create an interface of an application to allow users to perform various tasks such as inputting data, making selections, or triggering actions. The selection of GUI elements can facilitate user commands that enable the performance of some functionality. For example, a selection of a button GUI element can cause a request for information or services to be sent to the communication services platform 120. In some embodiments, the application 232C can include a browser-based application or a native application with a GUI interface.

In some embodiments, GUI information (e.g., GUI data) can be transmitted between the communication services platform 120 and client device 110A. The GUI information can be used to help render the GUI associated with application 232C at the client device. The GUI information can be transferred in a particular format (e.g., format A), such as a data interchange format. For example and in some embodiments, the format of GUI information can be in JavaScript Object Notation (JSON). JSON can refer to a data interchange format that can be used to transmit data (e.g., GUI information) between a server and application 232C (e.g., client device 110A). In some embodiments, JSON data can identify one or more of the structure, content and configuration of GUI elements of an application's GUI. In some embodiments, JSON data can be structured as key-value pairs. In some embodiments, the JSON data received from the server can be used to dynamically update or populate a GUI of application 232C. For example, the JSON data can identify text, images, GUI elements, lists or other elements that are rendered using hypertext markup language (HTML) or cascading style sheets (CSS). In some embodiments, format A (e.g., format of JSON data) can include a data format that specifies a structure and/or syntax of the data and/or specify how data is represented and/or organized within an application or exchanged between systems.

In some embodiments, data store 106 can include one or more of application 232A (format A), application 232B (format B), module A 238A (format A) through module N 240A (format A), module A 238B (format B) through module N 240B (format B), module modification A 242 (format A), and schema information 244.

In some embodiments, application 232B (format B) can include or represent an application that implements a GUI. In some embodiments, application 232B (format B) is in a particular format, such as format B. For example and in some embodiments, application 232B (format B) can include source code of application 232B written in a particular programming language (e.g. format B). In some embodiments, application 232B (format B) can represent the existing or base application. In some embodiments, application 232B can be the application that is provided by communication services platform 120 (and developed by communication services platform 120). In some embodiments, format B (e.g., format of a programming language) can refer to a particular format, such as a code format that specifies the syntax and/or rules of the structure of the code written the particular programming language.

In some embodiments, application 232A (format A) can be related to application 232B (format B). In some embodiments, application 232A (format A) can represent application 232B (format B) but be of a different format, such as format A. For example and in some embodiments, application 232A (format A) can represent application 232B (format B) (at least part thereof) using JSON data, such JSON configuration data. In some embodiments, application 232A (format) can represent a part of application 232B. For instance, application 232A can represent the GUI of application 232B.

In some embodiments, module A 238B (format B) through module N 240B (format B) can represent modules of application 232B (format B) written in a particular format. In some embodiments, the format of module A 238B (format B) through module N 240B (format B) can be the same format as application 232B (format B). In some embodiments, the format of module A 238B (format B) through module N 240B (format B) can be a different format than application 232B (format B). For example, module A 238B (format B) through module N 240B (format B) can be written in a programming language. The programming language of module A 238B (format B) through module N 240B (format B) can be the same programming language or a different programming language than used for application 232B (format B).

In some embodiments, one or more of module A 238A (format A) through module N 240B (format B) can be written or obtained by an organization associated with client devices 110A-110Z. In some embodiments, one or more of module A 238A (format A) through module N 240B (format B) are third-party modules (e.g., modules written by the organization that uses the services of communication services platform 120). One or more of module A 238A (format A) through module N 240B (format B) can be uploaded to communication services platform 120 for importation with application 232B (format B). In some embodiments, application 232B (format B) is a first-party application.

In some embodiments, module A 238A (format A) through module N 240A (format A) can correspond to or represent a respective one of module A 238B (format B) through module N 240B (format B). For instance, module A 238A (format A) can correspond to module A 238B (format B). In some embodiments, module A 238A (format A) through module N 240A (format A) can be in a different format than the respective ones of module A 238B (format B) through module N 240B (format B). In some embodiments, two or more of application 232A (format A), module A 238A (format A) and module N 240A (format A) can be of the same format. In some embodiments, module A 238A (format A) through module N 240B (format B) are each converted to generate a corresponding one of module A 238B (format B) through module N 240B (format B). For example and in some embodiments, module A 238A (format A) through module N 240A (format A) are stored as in a data interchange format (e.g., JSON data, such as JSON configuration data) representing respective ones of module A 238A (format A) through module N 240A (format A).

In some embodiments, module modification A 242 (format A) can represent modification data for a particular module, such as module A (e.g., module A 238B (format B)). Module modification A 242 (format A) can include instructions to modify module A 238B (format B). In some embodiments, module modification A 242 (format A) can identify one or more GUI elements and declarative instructions to modify the one or more GUI elements (e.g., add, remove, change, move, and so forth). In some embodiments, application 232A (format A), module A 238A (format A) through module N 240A (format A), and module modification A 242 (format A) can be represented in the same format. For example and in some embodiments, module modification A 242 (format A) is represented using a same data interchange format, such as a JSON data structure.

In some embodiments, schema information 244 can represent information for a particular schema that is implemented for data store 106 and/or the contents therein. A schema can refer to one or more of a structure, constraints or validation rules for data. In the context of databases, a schema can define the organization and relationships of data elements within a database. In the context of formats (e.g., languages), a schema can define a structure and/or constraints of a data format and/or content of a data format. In some embodiments, a schema can be specified by an administrator of the communication services platform 120. For example, the communication services platform 120 can implement a particular schema (e.g., define the schema) to control (e.g., “guardrail”) the changes and modifications that can be performed via a module or modification and/or module. For example and in some embodiments, the schema as defined by schema information 244 can control which GUI elements of a GUI application can be modified.

For example and in some embodiments, schema information 244 can define a data interchange schema (e.g., JSON schema_that is expressed in a particular format (e.g., format A, JSON format, etc.) that describes the expected structure and/or content of the data (e.g., JSON data). The data interchange schema (e.g., JSON schema) can be defined by communication services platform 120 and can serve as a standard for validating data (e.g., JSON data, such as JSON configuration data) to ensure that the data conforms to a set of rules and constraints.

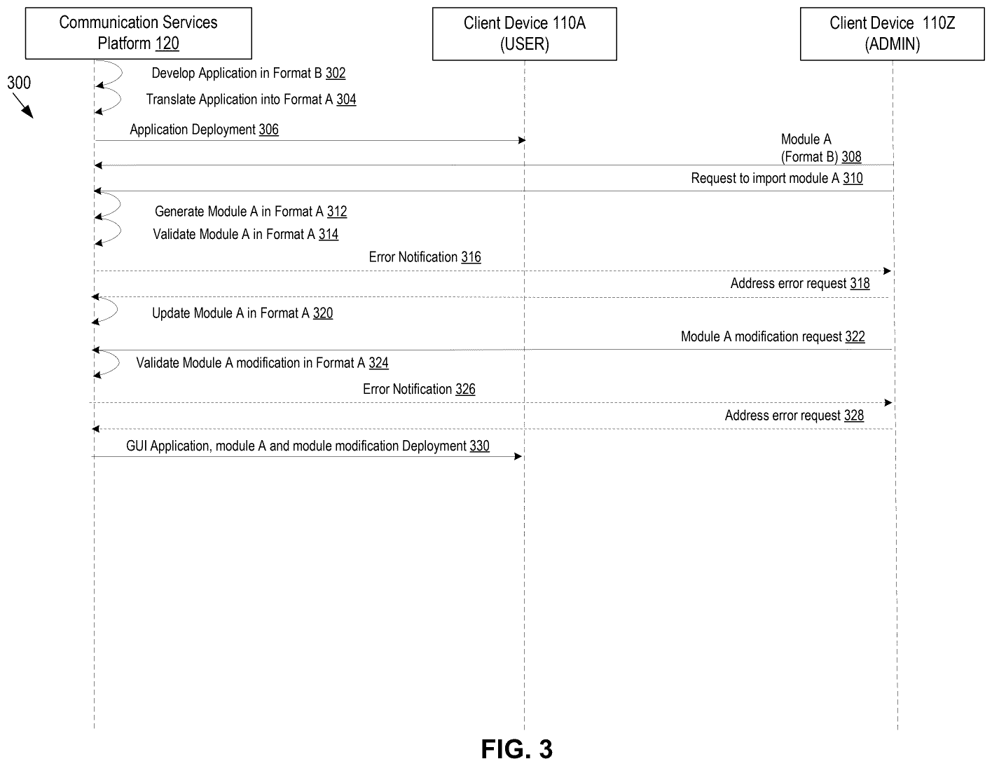

Elements of FIG. 1 and FIG. 2 are used with respect to FIG. 3 to help describe features of diagram 300. The operations described with respect to FIG. 3 are shown to be performed serially for the sake of illustration, rather than limitation. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible. In some embodiments, the same, different, fewer, or greater operations can be performed.

FIG. 3 illustrates a sequence diagram of modifying software modules in a declarative manner, in accordance with embodiments of the disclosure.

Diagram 300 illustrates communication services platform 120, client device 110A, and client device 110Z. In some embodiments, one or more of communication services platform 120, client device 110A using application 232C, client device 110Z using application 154Z, and in particular module modification component 151 thereon can implement the operations depicted in diagram 300. In some embodiments, client device 110Z can represent a client device that corresponds to user account associated with an administrator of an organization. Client device 110Z can implement module modification component 151 using application 154Z. Client device 110A can represent a client device 110A that corresponds to a user account associated with a user of an organization. Client device 110A can implement application 232C having a GUI where application 232C interacts with the communication services platform 120 to consume various services of the communication services platform 120.

It can be noted that application 232A, 232B and 232C are generally referred to as application 232. It can be further noted that application 232A, 232B and 232A generally refer to the same application. For example, application 232B can refer to the application that is written in a programming language in format B. Application 232A can represent a translation of at least part of the application 232B (e.g., GUI part) in another format, format A. The application 232C can be a version of application 232B installed and/or rendered on the client device 110A. In some embodiments, application 232C can be rendered based on one or more of application 232A, one or more software modules corresponding to application 232A, or one more software module modifications.

At operation 302, communication services platform 120 develops an application, such as application 232B (format B). The application 232B can include a GUI. For example, communication services platform 120 can develop an application 232B that allows users to consume services offered by communication services platform 120. The application 232B can be written in a particular programming language (e.g., format B).

At operation 304, communication services platform 120 can generate or translate at least part of application 232B into a different format, such as format A. In some embodiments, the part of the application 232B that is generated or translated can include the GUI of the application 232B. In some embodiments, the at least part of the application 232B is translated into a data interchange format (e.g., JSON data, such as JSON configuration data) for the application 232B.

At operation 306, the application 232C (which reflect one or more of application 232A and/or 232B) can be deployed and installed on one or more client devices, such as client device 110A.

At operation 308, client device 110Z sends to communication services platform 120 an identifier of a software module, such as software module A, for the application 232B. In some embodiments, the software module is provided in a particular format, such as format B. In some embodiments, software module A can be written in a particular programming language that is the same or different from the programming language of the existing application 232B. In some embodiments, the software module A can be used to customize and/or modify the GUI of the application 232B. In some embodiments, the organization associated with the user account of client device 110Z develops software module A. In some embodiments, the software module A can be developed by communication services platform 120 or another party and selected by the client device 110Z. In some embodiments, the source code of the software module A is sent to communication services platform 120 by client device 110Z. In some embodiments, the software module A can be stored at communication services platform 120 and/or associated with the particular organization corresponding to client device 110Z.

At operation 310, client device 110Z sends a request to communication services platform 120 to install or import software module A into the application (e.g., application 232A or 232B) having a GUI. In some embodiments, operation 308 and 310 can be combined. In some embodiments, the request identifies the software module A that is stored at communication services platform 120. In some embodiments, the request includes the software module written in format B.

At operation 312, communication services platform 120 generates or translates the software module A into a different format, such as format A. In some embodiments, to translate the software module A into a different format, communication services platform 120 can perform static code analysis of the source code of software module A in format B. In some embodiments, the source code of software module A in format B can include API calls to a particular API. The API calls can identify corresponding code in format A. The corresponding code in format A is identified or extracted from the source code of software module A in format B to generate software module A in format A.

For example and in some embodiments, the static code analysis is performed on software module A in format B. The static code analysis identifies portions (e.g., snippets) of JSON data identified by API calls in the source code (e.g. format B). The communication services platform 120 can generate JSON configuration data representing software module A using the identified portions of JSON data.

At operation 314, communication services platform 120 can validate software module A. Validation can refer to one or more operations that check whether data or code adheres to one or more of rules, constraints or specifications. Validation can include comparing input data (e.g., JSON data) against criteria to determine the data's validity. In some embodiments, validation does not include transforming the validated data. For example and in some embodiments, validation does not include transforming code, such as source code, into executable code. In some embodiments, the validation operation uses software module A in format A. In some embodiments, validation can include determining whether any conflicts exist between software module A in format A and one or more of the application 232A or one or more software modules associated with the application 232A. For example, software module A can define a GUI element differently than another software module (e.g., software module N), which can result in a conflict.

In some embodiments, to perform a validation operation the application 232A in format A and one or more software modules in format A can be used for validation. For example, the JSON configuration data for software module A can be compared with the JSON configuration data for software module N to determine any conflicts.

In some embodiments, the validation operation can include determining whether software module A in format A conforms to a particular schema. For example, the particular schema may prohibit changes to GUI element A. If the validation operation determines that software module A in format A attempts to change GUI element A, the validation can return an error to client device 110Z. In some embodiments, the schema can correspond to a particular format, such as format A. For example, the JSON schema can provide a way to validate JSON data (e.g., structured data in a JSON format).

At operation 316, responsive to determining that the validation is unsuccessful, communication services platform 120 can send to client device 110Z an error notification. In some embodiments, the error notification can indicate that the validation was unsuccessful. In some embodiments, the error notification can identify whether the error was a conflict error and/or an error related to schema. In some embodiments, the error notification can identify or describe the particular error(s). In some embodiments, the error notification can propose a resolution to the error.

At operation 318, client device 110Z can send instructions on addressing the error identified in the error notification at 318. In some embodiments, client device 110Z can request to modify the software module that is being validated, such as software module A in format A. In some embodiments, client device 110Z can request to modify another software module that is different than the software module A that is being validated. In some embodiments, client device 110Z can request to modify the application 232, such as the application 232A in format A. In some embodiments, client device 110Z can send one or more API calls, such as API calls of a declarative API to address the errors. In some embodiments, the client device 110Z can request to re-validate software module A in format by sending an API call requesting validation of a particular software module identified in the request. Operation 314 can be repeated for re-validation.

At operation 320, responsive to receiving instructions from operation 318, communication services platform 120 can update the respective software such as one or more of the software module being validated (e.g., software module A in format A), other software module(s) (e.g., in format A) that is different than the software module that is being validated, and/or the application 232A (e.g., in format A). In some embodiments, to update the respective software, the respective software in format A can be updated.

At operation 322, client device 110Z can send to communication services platform 120 a request to modify the software module, such as software module A. As noted, the software module A can be originally written in format B and later converted to format B. In some embodiments, the request is performed using an API call of a declarative API. In some embodiments, the request identifies a software module. For example, the request can be a declarative request that requests that GUI element X of software module A be moved, changed or removed, for instance. In some embodiments, the request includes the software module modification written in a format, such as format A. In some embodiments, the request can identify the software module modification. For example, the request can include an identifier of a software module modification that is stored at communication services platform 120.

In some embodiments, the request to modify the software module includes a selection of a GUI element of the application (e.g., application 154Z) of client device 110Z. The GUI element can represent a corresponding GUI element defined by the software module A (e.g., format A). For example, the application 154Z can include a GUI. The GUI of application 154Z can visually display the GUI elements that represent corresponding GUI elements defined by the software module A (e.g., format A) and/or application 232A. The user of client device 110A can modify the GUI elements displayed in the GUI of application 154Z. For example, the user can move GUI element A displayed in the GUI application 154Z, where GUI element A represents a corresponding GUI element defined by software module A (e.g., format A). The user interaction with the GUI of application 154Z can initiate an API call of a declarative API to be sent the communication services platform 120. The API call can declaratively instruct communication services platform 120 to modify software module A in format A to reflect the changes the user-initiated command using the GUI of the application 154Z (e.g., move GUI element A of software module A to a location selected by the user).

At operation 324, communication services platform 120 validates the software module modification, such as the software module modification of module A of operation 322. In some embodiments, the software module modification in format A is validated. It can be appreciated that the description of operation 314 can also apply to operation 324.

In some embodiments, validation does not include transforming the validated data (e.g., software module modification). In some embodiments, the validation operation uses software module modification in format A (or software module A in format A). In some embodiments, validation can include determining whether any conflicts exist between software module modification and one or more of software module A, the application 232 (e.g., application 232A) or one or more software modules associated with the application 232 (e.g., application 232A). The conflicts check can be performed using versions of the aforementioned software in format A, in some embodiments. For example, software module modification can define a GUI element differently than another software module (e.g., software module N), which can result in a conflict.

In some embodiments, to perform a validation operation one or more of the applications 232A in format A and one or more software modules in format A can be used for validation. For example, the JSON configuration data for software module A can be compared with the JSON configuration data for software module modification of module A to determine any conflicts.

In some embodiments, the validation operation can include determining whether software module modification to software module A conforms to a particular schema. For example, the particular schema may prohibit changes to GUI element N. If the validation operation determines that software module modification of software module A attempts to change GUI element N, the validation can return an error to client device 110Z. In some embodiments, the schema can correspond to a particular format, such as format A. For example, the JSON schema can provide a way to validate JSON data (e.g., structured data in a JSON format).

At operation 326, responsive to determining that the validation is unsuccessful, communication services platform 120 can send to client device 110Z an error notification. In some embodiments, the error notification can indicate that the validation was unsuccessful. In some embodiments, the error notification can identify whether the error was a conflict error and/or an error related to schema. In some embodiments, the error notification can identify or describe the particular error(s). In some embodiments, the error notification can propose a resolution to the error.

At operation 328, client device 110Z can send instructions on addressing the error identified in the error notification at 318. In some embodiments, client device 110Z can request to modify the software module modification that is being validated, such as software module modification of software module A. In some embodiments, client device 110Z can request to modify another software module that is different than the software module A corresponding to the software module modification that is being validated. In some embodiments, client device 110Z can request to modify the application 232, such as the application 232A in format A. In some embodiments, client device 110Z can send one or more API calls, such as API calls of a declarative API, to address the errors. In some embodiments, the client device 110Z can request to re-validate software module A by sending an API call of a declarative API requesting validation of a particular software module modification identified in the request.

At operation 330, communication services platform 120 deploys the updated application 232 that includes the modified software module A. In some embodiments, communication services platform 120 provides for presentation the GUI of application 232C based on one or more of application 232A (e.g., in format A), software module A in format A (e.g., software module A 238A), the software module modification in format A (e.g., module modification A 242), and/or any other software modules in format A that correspond to application 232A.

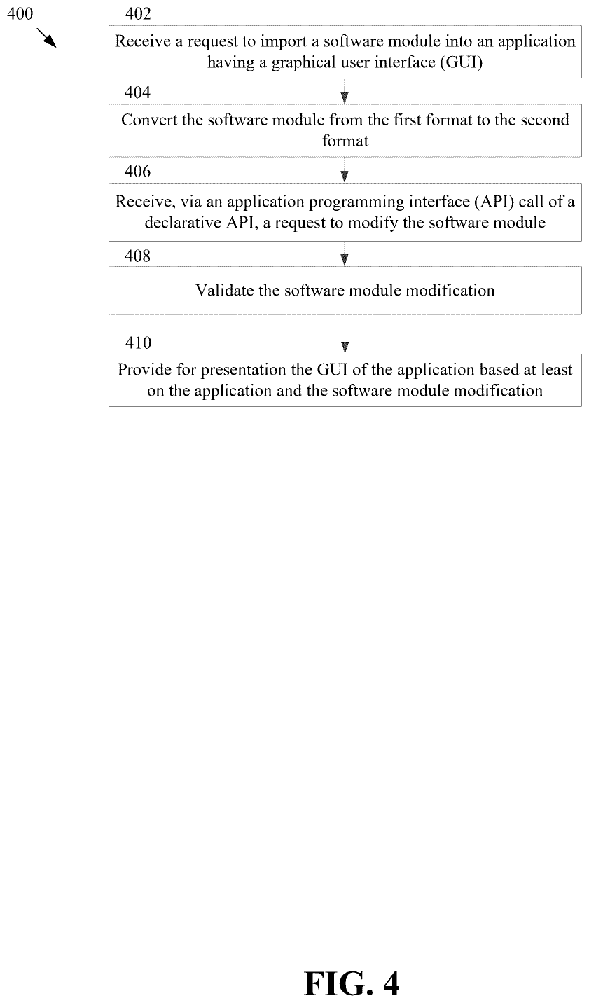

Method 400 of FIG. 4 and/or each of the aforementioned method's individual functions, routines, subroutines, or operations can be performed by a processing device, having one or more processing units (CPU) and memory devices communicatively coupled to the CPU(s). In some embodiments, the method 400 can be performed by a single processing thread or alternatively by two or more processing threads, each thread executing one or more individual functions, routines, subroutines, or operations of the method. Method 400 as described below can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, method 400 is performed by module modification component 151 described in FIGS. 1 and 2. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible. In some embodiments, the same, different, fewer, or greater operations can be performed. It may be noted that elements of FIG. 1-3 may be used herein to help describe FIG. 4.

FIG. 4 depicts a flow diagram of an example method 400 for modifying a software module using a declarative API, in accordance with some embodiments of the disclosure. In some embodiments, method 400 can be performed by communication services platform 120, and in particular module modification component 151 of communication services platform 120.

At operation 402, processing logic receives a request to import a software module into an application having a graphical user interface (GUI). In some embodiments, the request is from a client device and by a software as a service (SaaS) platform. In some embodiments, the software module is to modify the GUI of the application. In some embodiments, the software module is written in a first format (e.g., format B).

At operation 404, processing logic converts the software module from the first format to the second format (e.g., format A). In some embodiments, processing logic converts at least part of the software module, such as the GUI, from the first format to the second format. In some embodiments, the second format corresponds to a format associated with data interchange format. In some embodiments, the second format corresponds to a format associated with JavaScript Object Notation (JSON).

At operation 406, processing logic receives, via an application programming interface (API) call of a declarative API, a request to modify the software module. In some embodiments, the request to modify the software module includes a request to modify a GUI element corresponding to the software module. In some embodiments, the request to modify the software module includes the software module modification written in a second format. In some embodiments, the request to modify the software module includes a user selection of a GUI element representing a corresponding GUI element defined by the software module.

At operation 408, processing logic validates the software module modification. In some embodiments, processing logic validate the software module modification responsive to receiving the request to modify the software module.

In some embodiments, validating the software module modification includes determining whether the software module modification written in the second format conforms to a schema associated with the second format.

In some embodiments, validating the software module modification includes determining whether the software module modification written in the second format conflicts with another software module of the application.

At operation 410, processing logic provides for presentation the GUI of the application based at least on the application and the software module modification written in the second format.

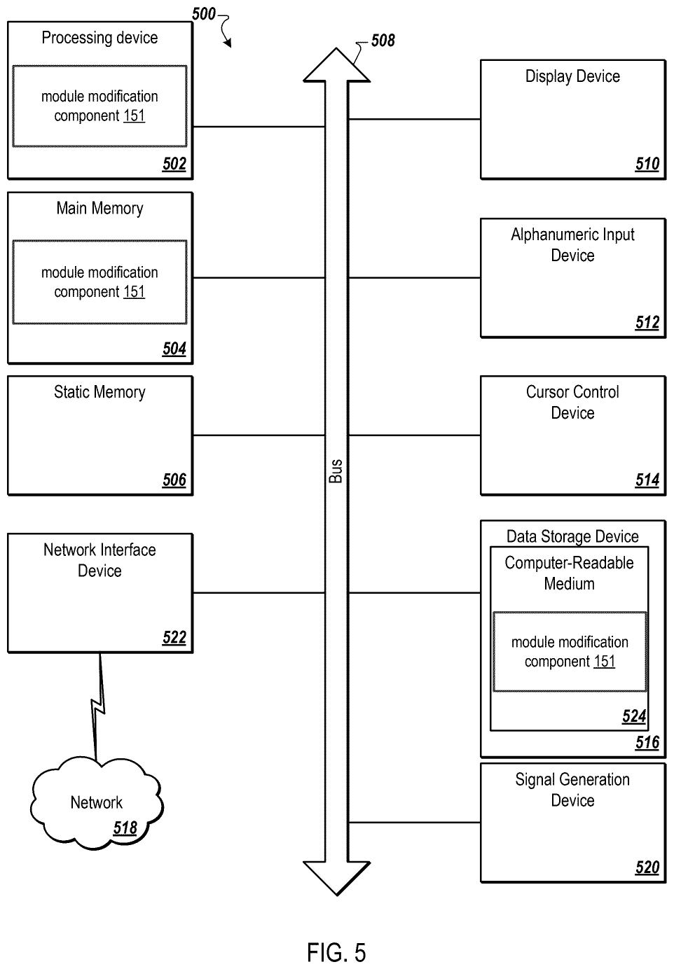

FIG. 5 is a block diagram illustrating an exemplary computer system 500, in accordance with an embodiment of the disclosure. The computer system 500 executes one or more sets of instructions that cause the machine to perform any one or more of the methodologies discussed herein. Set of instructions, instructions, and the like may refer to instructions that, when executed by computer system 500, cause computer system 500 to perform one or more operations of module modification component 151. The machine may operate in the capacity of a server or a client device in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions to perform any one or more of the methodologies discussed herein.

The computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 516, which communicate with each other via a bus 508.

The processing device 502 represents one or more general-purpose processing devices such as a microprocessor, central processing unit, or the like. More particularly, the processing device 502 may be a complex instruction set computing (CISC) microprocessor, reduced instruction set computing (RISC) microprocessor, very long instruction word (VLIW) microprocessor, or a processing device implementing other instruction sets or processing devices implementing a combination of instruction sets. The processing device 502 may also be one or more special-purpose processing devices such as an application specific integrated circuit (ASIC), a field programmable gate array (FPGA), a digital signal processor (DSP), network processor, or the like. The processing device 502 is configured to execute instructions of the system architecture 100 and module modification component 151 for performing the operations discussed herein.

The computer system 500 may further include a network interface device 522 that provides communication with other machines over a network 518, such as a local area network (LAN), an intranet, an extranet, or the Internet. The computer system 500 also may include a display device 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 516 may include a non-transitory computer-readable storage medium 524 on which is stored the sets of instructions of the system architecture 100 of module modification component 151 embodying any one or more of the methodologies or functions described herein. The sets of instructions of the system architecture 100 and of module modification component 151 may also reside, completely or at least partially, within the main memory 504 and/or within the processing device 502 during execution thereof by the computer system 500, the main memory 504 and the processing device 502 also constituting computer-readable storage media. The sets of instructions may further be transmitted or received over the network 518 via the network interface device 522.

While the example of the computer-readable storage medium 524 is shown as a single medium, the term “computer-readable storage medium” can include a single medium or multiple media (e.g., a centralized or distributed database, and/or associated caches and servers) that store the sets of instructions. The term “computer-readable storage medium” can include any medium that is capable of storing, encoding or carrying a set of instructions for execution by the machine and that causes the machine to perform any one or more of the methodologies of the disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, in order to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
receiving, from a client device and by a software as a service (SaaS) platform, a request to import a software module into an application having a graphical user interface (GUI), the software module to modify the GUI of the application and written in a first format;
receiving, via an application programming interface (API) call of a declarative API, a request to modify the software module, the request identifying a software module modification written in a second format; and
providing for presentation the GUI of the application based at least on the application and the software module modification in the second format.

2. The method of claim 1, wherein the request to modify the software module comprises a request to modify a GUI element corresponding to the software module.

3. The method of claim 1, comprising:
converting the software module from the first format to the second format.

4. The method of claim 3, wherein the second format corresponds to a format associated with JavaScript Object Notation (JSON).

5. The method of claim 1, further comprising:
responsive to receiving the request to modify the software module, validating the software module modification.

6. The method of claim 4, wherein validating the software module modification comprises:
determining whether the software module modification written in the second format conforms to a schema associated with the second format.

7. The method of claim 4, wherein validating the software module modification comprises:
determining whether the software module modification written in the second format conflicts with another software module of the application.

8. The method of claim 1, wherein the request to modify the software module comprises the software module modification written in a second format.

9. The method of claim 1, wherein the request to modify the software module comprises a user selection of a GUI element representing a corresponding GUI element defined by the software module.

10. A system, comprising:
a memory; and
a processing device, coupled to the memory, to perform operations comprising:
receiving, from a client device and by a software as a service (SaaS) platform, a request to import a software module into an application having a graphical user interface (GUI), the software module to modify the GUI of the application and written in a first format;
receiving, via an application programming interface (API) call of a declarative API, a request to modify the software module, the request identifying a software module modification written in a second format; and
providing for presentation the GUI of the application based at least on the application and the software module modification in the second format.

11. The system of claim 10, wherein the request to modify the software module comprises a request to modify a GUI element corresponding to the software module.

12. The system of claim 10, the operations further comprising:
converting the software module from the first format to the second format.

13. The system of claim 12, wherein the second format corresponds to a format associated with JavaScript Object Notation (JSON).

14. The system of claim 10, the operations further comprising:
responsive to receiving the request to modify the software module, validating the software module modification.

15. The system of claim 13, wherein validating the software module modification comprises:
determining whether the software module modification written in the second format conforms to a schema associated with the second format.

16. The system of claim 13, wherein validating the software module modification comprises:
determining whether the software module modification written in the second format conflicts with another software module of the application.

17. The system of claim 10, wherein the request to modify the software module comprises the software module modification written in a second format.

18. The system of claim 10, wherein the request to modify the software module comprises a user selection of a GUI element representing a corresponding GUI element defined by the software module.

19. A non-transitory computer-readable medium comprising instructions that, responsive to execution by a processing device, cause the processing device to perform operations, comprising:
receiving, from a client device and by a software as a service (SaaS) platform, a request to import a software module into an application having a graphical user interface (GUI), the software module to modify the GUI of the application and written in a first format;
receiving, via an application programming interface (API) call of a declarative API, a request to modify the software module, the request identifying a software module modification written in a second format; and
providing for presentation the GUI of the application based at least on the application and the software module modification in the second format.

20. The non-transitory computer-readable medium of claim 19, wherein the request to modify the software module comprises a request to modify a GUI element corresponding to the software module.
